(19) United States
(12) Patent Application Publication
(10) Pub. No.: US 2017/0327048 A1
(43) Pub. Date: Nov. 16, 2017

(54) SYSTEMS AND METHODS FOR A STORAGE UNIT

(71) Applicant: Brian FERNANDEZ, Mendham, NJ (US)

(72) Inventor: Brian FERNÁNDEZ, MENDHAM, NJ (US)

(21) Appl. No.: 15/113,095

(22) PCT Filed: Jan. 21, 2015
(86) PCT No.: PCT/US15/12215

§ 371 Date: Aug. 7, 2017

Related U.S. Application Data
(60) Provisional application No. 61/930,450, filed on Jan. 22, 2014.

(51) Int. Cl. B60R 7/04; A47B 57/06; A47B 43/00

(52) U.S. Cl. CPC B60R 7/043; A47B 43/00; A47B 57/06

(57) ABSTRACT

The present invention is directed to a foldable storage unit for use in multiple setting and in collaboration with other equipment including vehicles and containers structures.

### CROSS-REFERENCE TO RELATED APPLICATION

This application claims priority to U.S. Provisional Application No. 61/930,450 filed Jan. 22, 2014, incorporated herein in its entirety.

### FIELD OF THE INVENTION

The invention is directed to a storage unit system.

### BACKGROUND OF THE INVENTION

Existing storage components typically include a number of heavy-gauge steel shelving and cabinet units which must be custom designed for different model vehicles. Once the components are installed, they cannot be easily removed or rearranged. Accordingly, it would be highly desirable to provide a storage area for tools, supplies and equipment that is lightweight, portable, adjustable, and is universal so as to accommodate any model vehicle or cabinet.

There are several disadvantages associated with storage units currently known. Storage units known in the art are essentially standard structures that are not easily reconfigurable or adjustable. Most commonly, shelves that are welded to the end and back panels are not removable (or, at least, not easily removed). In storage units known in the art, shelves or drawers are connected to both back panels and the end panels and therefore cannot be adjusted or reconfigured without either completely removing the unit from a vehicle or unmounting the end panels and back panel.

It may be advantageous or even necessary to house an item in the vehicle or cabinet for which no space currently exists or is inaccessible for use. Therefore, it would be beneficial to reconfigure the storage system by moving or adjusting shelving as part of a “mobile” or stationary unit. Therefore, there is a need for a storage system and storage units that are modular, reconfigurable, and/or customizable by the user. Further, there is also a need for a storage unit or system for vehicles wherein the means for adjusting or reconfiguring the system is easily accessible to the user. Additionally, there is also need for a storage system that is lighter in weight compared to conventional storage units.

### BRIEF SUMMARY OF THE INVENTION

The present invention is directed to a foldable storage unit for use in multiple setting and in collaboration with other equipment including vehicles and containers structures. The present invention provides various concepts working in synergistic collaboration to provide a use of space and convenience. The engineering concepts directed to the core construction and designs of the present invention provide optimum use of dimensional forces to establish ease in movement with reduced physical labor in use.

In a first embodiment, the invention is directed to a cargo area storage system having a base structure with multiple parallel components, wherein the multiple parallel components have bottom portion and a top portion, at least one adjustable shelving unit, a sound deadening securing system integral with each multiple parallel components of the base structure, and a motor.

In another embodiment, the invention is directed to a storage unit wherein the motor is integral with a drive train contacting the at least one adjustable shelving unit, the drive train is integral with the multiple parallel components of the base portion.

In another embodiment, the invention is directed to a storage unit wherein the adjustable shelving unit has a contoured portion complimentary to fit between the multiple parallel base portion, wherein the countered portion has a first proximal end portion. The adjustable shelving unit is traversed by a rod having at least one extendible end component on either end which extends into the motor in greater amounts as the adjustable shelving unit is rotated into an extended position perpendicular to the multiple parallel components.

In another embodiment, the invention is directed to a method to organize cargo in a vehicle cargo area storage system including securing a cargo device of in a cargo area and adjusting the at least one adjustable shelving unit to a defined position on the multiple parallel components between the bottom portion and a top portion, wherein securing the cargo device includes positioning the bottom portion of the multiple parallel components of the base portion via the contacting side to a floor of a cargo section of a vehicle and adjusting the connecting component to extend the distal end of the securing system to secure the cushioned contacting foot to a ceiling of the cargo area of a vehicle.

### BRIEF DESCRIPTION OF THE DRAWINGS

FIG. 1 is a front view of a first embodiment cargo area storage system of the present invention;

FIG. 2 is a top view of a first embodiment cargo area storage system of the present invention.

FIG. 2A is a side view of a first embodiment cargo area storage system of the present invention; and

FIG. 2B is a side view of a motor of a first embodiment cargo area storage system of the present invention;

FIG. 2C is a side view of the embodiment in the folded position in the cargo area of a sport utility vehicle.

FIG. 3 is a side view of an alternate motor design of the first embodiment;

FIG. 4 is a side view of an alternate motor design of the first embodiment;

FIG. 5 is a top view of the frame of the shelf of the first embodiment shelf of the present invention;

FIG. 6 is a side view of the motor of another embodiment of the present invention;

FIG. 6A is a top view of the motor of the embodiment of FIG. 6;

FIG. 7 is top view of another embodiment of the present invention; and

FIG. 7A is a top view of the motor of the embodiment of FIG. 7.

### DETAILED DESCRIPTION OF TIE INVENTION

Certain terminology is used herein for convenience only and is not to be taken as a limitation on the present invention. The terminology includes the words specifically mentioned, derivatives thereof and words of similar import. The embodiments discussed herein are not intended to be exhaustive or to limit the invention to the precise form disclosed. These embodiments are chosen and described to best explain the principle of the invention and its application and practical use and to enable others skilled in the art to best utilize the invention.

The present invention is directed to a foldable and/or portable storage unit for use in multiple settings and in collaboration with other equipment including vehicles and container structures. The present invention provides various concepts working in synergistic collaboration to provide a use of space and convenience, more particularly but not limited to, incorporating designs which use force applied in perpendicular directions to provide increased stability in the installed position. More particularly, by increasing the weight on the shelving component in a perpendicular direction, the structure directs more pressure on the base components which provide stability for the present invention in the installed and folded position via the surrounding structures, e.g. cargo area of a vehicle. The engineering concepts directed to the core construction and designs of the present invention, in addition to the ability to use various lightweight materials and application accessories, provide optimum use of dimensional forces to establish ease in movement with reduced physical labor in installation and removal, in addition to reduced cost.

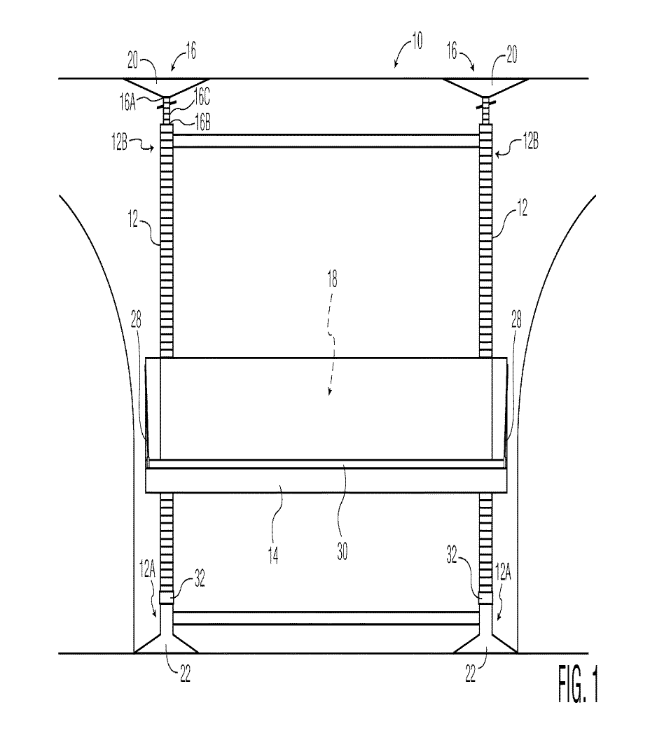

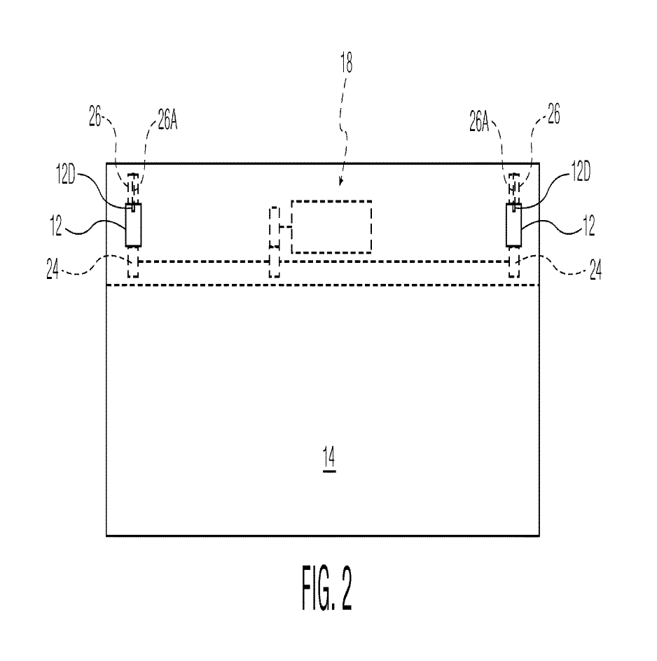

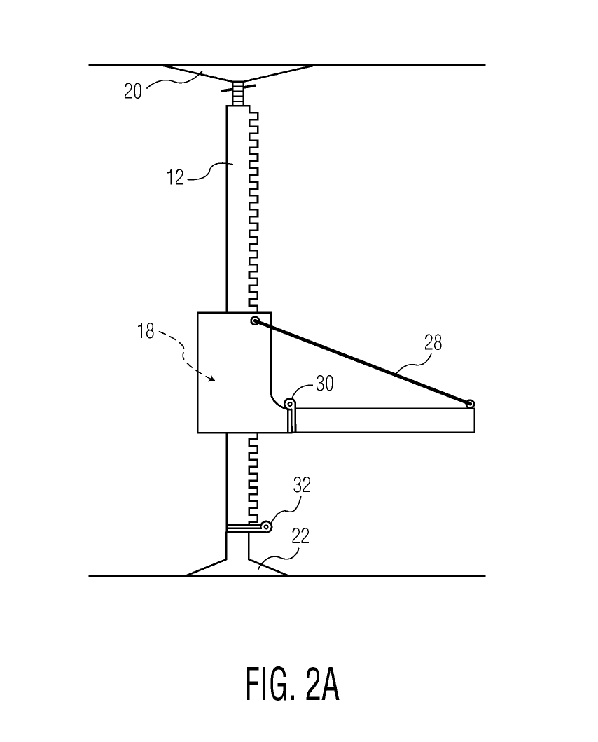

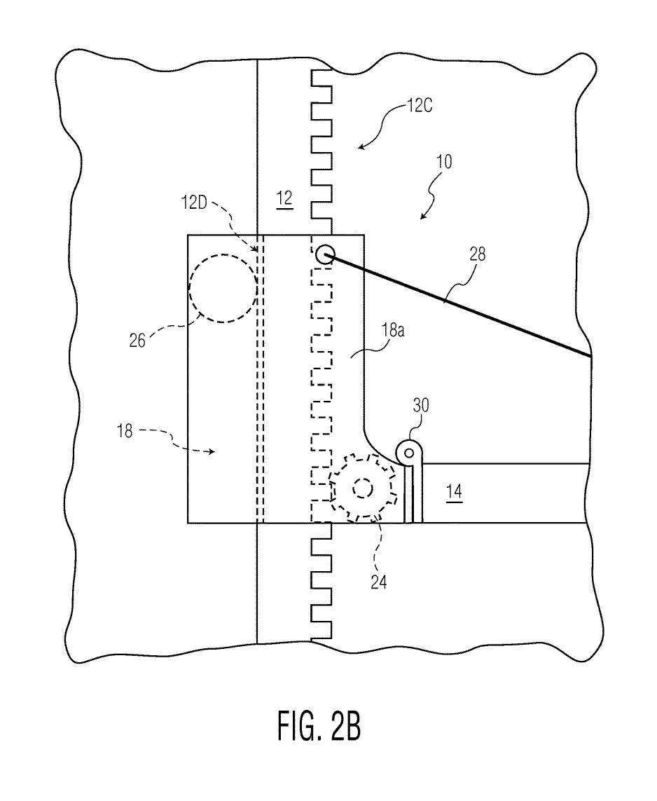

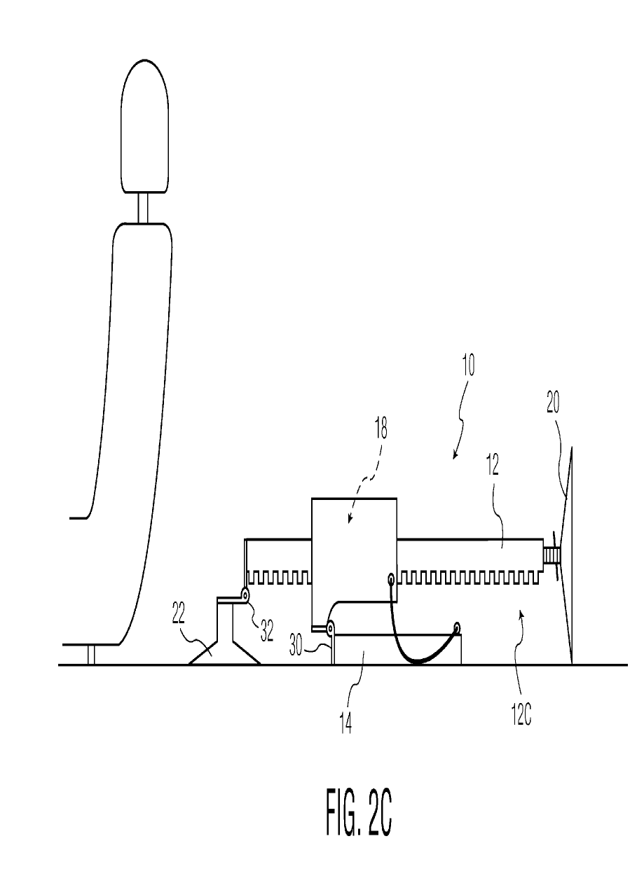

Referring to FIGS. 1, 2 and 2A in a first embodiment, the invention is directed to a cargo area storage system 10 having a base structure with multiple parallel components 12, wherein the multiple parallel components 12 have bottom portion 12A and a top portion 12B, at least one adjustable shelving unit 14, a sound deadening securing system 16 integral with each multiple parallel components of the base structure 12, and a motor 18. The motor is defined in the present invention as a means of locomotion for the shelving (single or multiple) within the concepts of force and pressure as described herein. It should be recognized that multiple embodiment designs of the motor can be used within the concept of the present invention without limiting the scope or being restricted to a particular embodiment.

The sound deadening securing system 16 has a distal end 16B and a proximal end 16A, wherein the proximal end 16A is connected to the multiple parallel components 12 via a connecting component 16C, wherein the connecting component 16C allows for adjustable extension of the securing system 16. The multiple parallel components of the base structure can include multiple telescoping components as the connecting component 16C which will extend in the same direction as the multiple parallel components 12. Most commonly, the connecting components has a locking device.

The distal end of the securing system 16B includes a cushioned contacting apparatus 20, wherein the cushioned contacting apparatus 20 is designed to disperse pressure provided by the multiple parallel components of the base structure 12 in a substantially perpendicular direction. The ability to disperse pressure allows a secure fit of the system 10 thereby eliminating any “rattling” or other sound but also ensures there is no damage to a contact surface, e.g. the interior ceiling of a cargo area of a sport utility vehicle (SUV). The cushioned contacting device can be of a variety of absorbent material, such as rubber or plastic, which can conform to the contour of a contact surface while forming a secure contact.

The bottom portion 12A of the multiple parallel components of the base portion 12 has a contacting side 22 which is complementary to a supporting structure. The contacting side 22 can be a firm material, e.g. rubber, position against a supporting surface, e.g. the bottom of a cargo area in a SUV or van, will be substantially flat and thereby complete contact will be easily obtain without contouring to “curving” surfaces.

The at least one adjustable shelving unit 14 is integral with the multiple parallel components of the base portion 12 via the motor 18 to allow movement between the top portion 12B and bottom portion 12A of the multiple parallel components 12. The shelf 14 integrated with the motor 18 to ensure secure contact of the shelf 14 and motor 18 to the multiple parallel components focusing on the defined perpendicular arrangement shelf 14 and parallel components 12. As will be recognized by those skilled in the art, this type of alignment will 1) support firm engagement of the motor 18 and parallel components 12 and 2) reduce overall noise, e.g. rattling.

Referring to FIG. 2B, in the present embodiment, the motor 18 is a one-piece integrated unit traversed by the multiple parallel component 12, wherein a gear 24 on a proximal end of the one-piece integrated unit 18A is aligned with a gear surface on a first side 12C of the multiple parallel component 12. At least one wheel 26 is aligned with a second side of the multiple parallel component 12D, wherein the shelve 14 is aligned with the gear 24 so as weight on the shelve 14 increases in a perpendicular direction, pressure in engaging the gear 24 into the gear surface on a first side 12C of the multiple parallel component 12 is increased. As discussed herein, the perpendicular alignment of the shelf 14 and motor 18 with the traversing multiple parallel component 12 supports the engineering concepts which provides construction integrity resulting in the objective of durability and elimination of noise.

The at least one wheel 26 has a contacting surface 26A complementary to the surface of the second side of the multiple parallel component 12D to maintain alignment and substantially eliminate friction contact in a perpendicular direction of the multiple parallel component 12. One skilled in the art would recognize that complimentary surfaces are designed to reduce friction and give further support to maintaining alignment during movement.

Referring again to FIGS. 1, 2 and 2A the one-piece integrated unit 18 further comprises a retractable brace bar 28 extending from a distal end of the one-piece integrated unit 12B to the distal end of the shelve 14A. Further, the shelf 14 is connected to the one-piece integrated unit 18 via a hinge 30 and each multiple parallel component 12 comprises a hinge 32 proximal its bottom portion 12B.

The hinges 30, 32 are positioned to allow the storage system 10 to easily fold as best illustrated in FIG. 2C to a substantially flat position. The sound deadening securing system 16, and most importantly, the cushioned contacting apparatus 20 provides reduction in movement and elimination of “noise” in the folded position thereby recognizing a dual functionality therein. The sturdy positioning of the system 10 while in the folded position, allows for items to be placed on the shelf in the folded position so space is not wasted or required removal when not in the “expanded” position. A locking strap may be included to further secure the invention in the folded position.

The invention will now be described in additional designs and embodiments wherein like reference numbers are meant to illustrate like features.

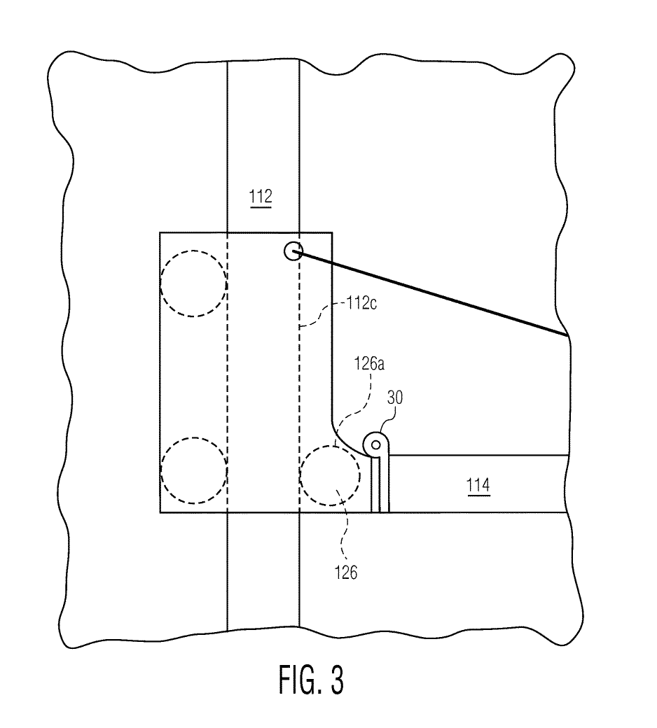

Referring to FIG. 3, an alternate design is illustrated wherein the gear is replaced with a wheel 126 with a contacting surface 126A complementary to the surface of a first side of the multiple parallel components 112C to maintain alignment and substantially eliminate friction contact in a perpendicular direction of the multiple parallel component 112. As in the “gear design” of the present embodiment, the shelve 114 is aligned so the weight on the shelve 114 increases in a perpendicular direction, pressure in engaging the wheel 126 into the surface of a first side of the multiple parallel component 112C is increased. One skilled in the art would recognize that complimentary surfaces are designed to reduce friction and give further support to maintaining alignment during movement.

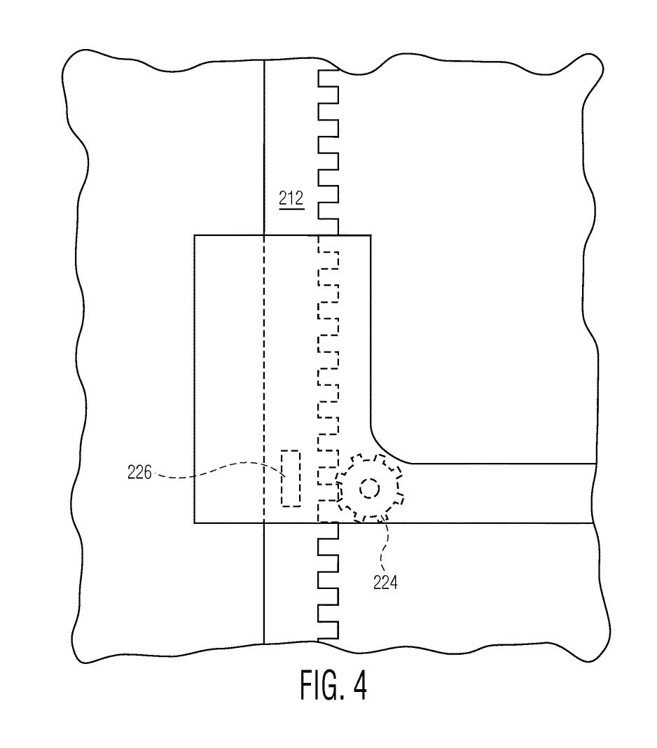

Referring to FIG. 4, an alternate design is illustrated wherein the single wheel 226 is positioned within the m multiple parallel component 212, with a gear 224 positioned substantially linear. The positioning of the wheel 226 and gear 224 provide additional pressure for engagement as the weight on the shelf increases.

As the system of the present invention is made of lightweight but sturdy material, removal and installation is easy and can be accomplished by any person. The weight of the entire system will vary based on materials used. Thus, the materials used will reflect the specific needs of the invention and therefore, cost can be controlled so as to ensure commercial success.

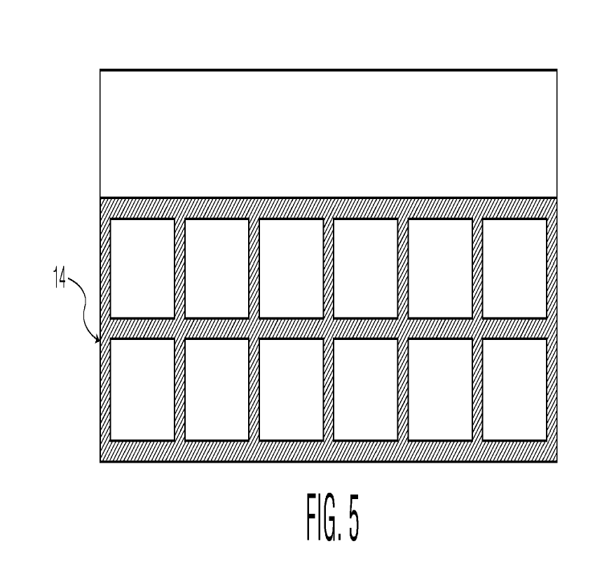

Referring to FIG. 5, in a particular beneficial design, the shelf 14 is made of a lightweight aluminum frame covered with a form material which will not lose shape and will limit any noise from vibration or rattling in the use or folded position. It will be recognized that different embodiments which require different strengths will vary in weight.

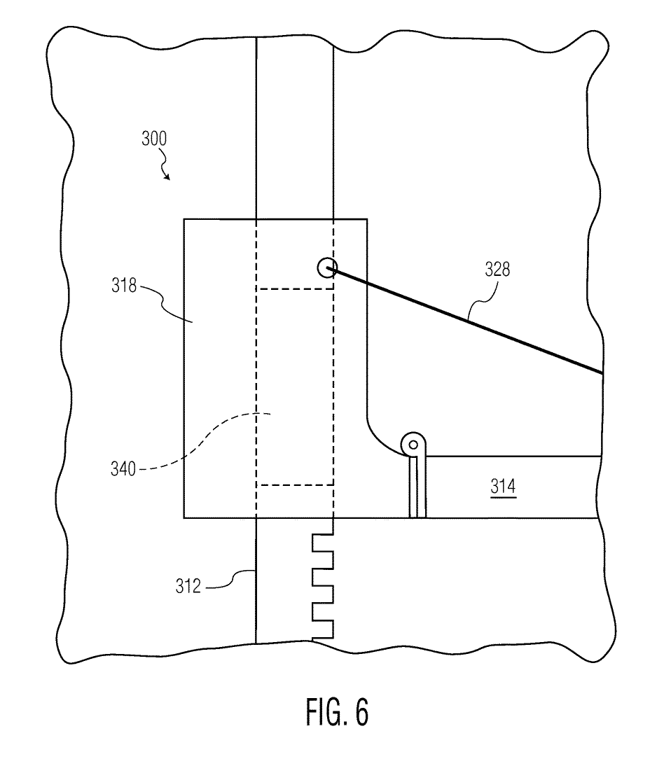

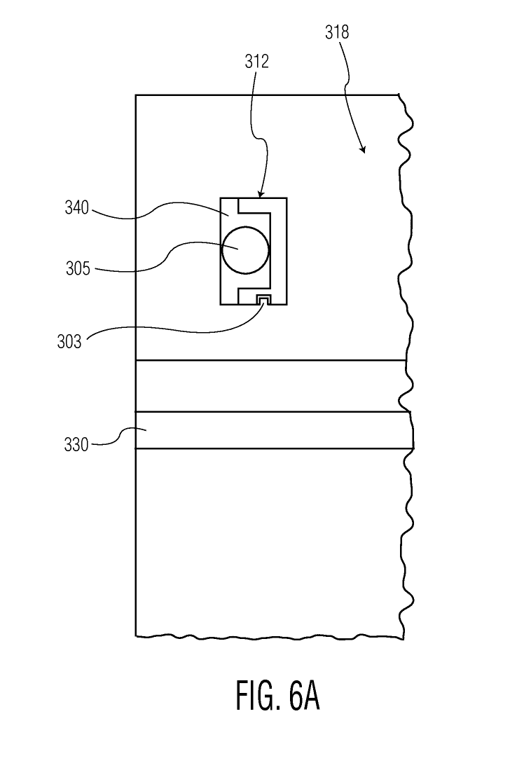

Referring to FIGS. 6 and 6A, in another embodiment, the invention is directed to storage unit 300 wherein the motor 318 is integral with a drive train 340 contacting the at least one adjustable shelving unit 314; the drive train 340 is integral with the multiple parallel components 312 of the base portion.

Referring to FIG. 6A, the motor 318 includes locking peg 303 complementary to grooves on the multiple parallel components 312 to lock the shelf 314 in the desired position. The drive train 340 includes a rotating component 305 which rotates at 360 degrees to activate the drive train 340 for movement of the at least one adjustable shelving unit 314 in a parallel direction to the multiple parallel components 312 of the base portion. As in the previous embodiment, the weight of the shelf 314 in the extended position ensures the weight on the drive train 340 is distributed to provide “sliding” movement with minimal or no friction on the multiple parallel components 312. As will be recognized by those skilled in the art, the forces being directed by the extending arm 328 are counter to the force “of the weight” of the shelf 314 and therefore maintain the drive train 340 in a position for ease (e.g. frictionless) movement as it “slides” on the multiple parallel components 312.

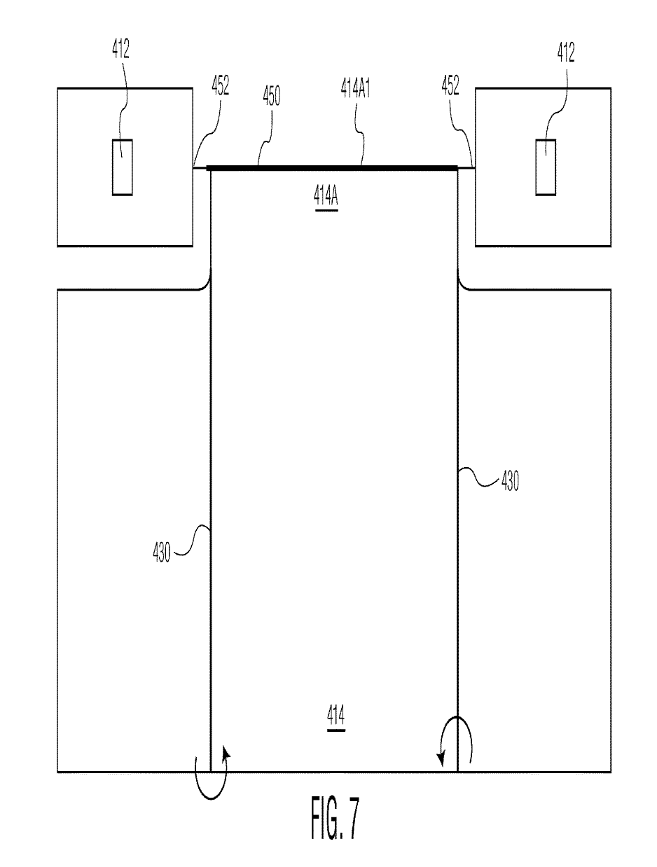

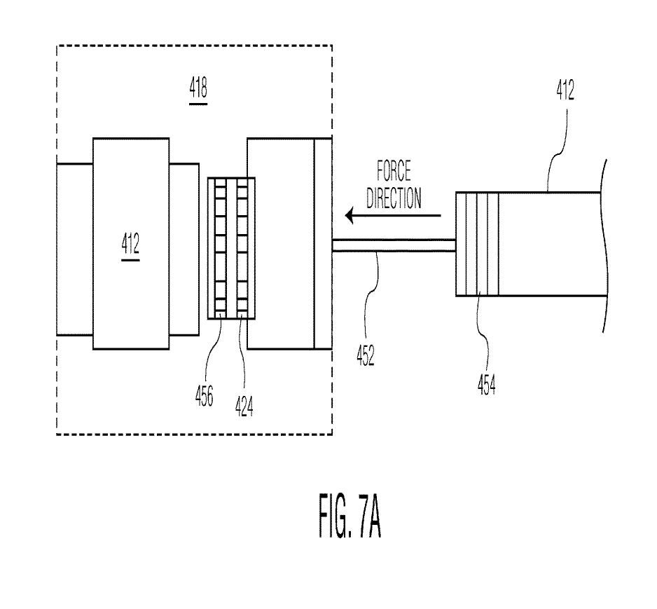

Referring to FIGS. 7 and 7a, in yet another embodiment, the invention is directed to storage unit 400 wherein the adjustable shelving unit 414 has an contoured portion complimentary 414A to fit between the multiple parallel base portion 412, wherein the countered portion 414A has a first proximal end portion 414A1. The adjustable shelving unit 414 is traversed by a rod 450 having at least one extendible end component 452 on either end which extends into the motor 418 in greater amounts as the adjustable shelving unit 414 is rotated into an extended position perpendicular to the multiple parallel components 412.

As best illustrated in FIG. 7A, the extendible end component 452 includes a ratcheting gear 454 extending the at least one extendible end component 450 into the motor 418. Therefore, as in the previous embodiments, as the weight on the shelf 414 increases the force of the gear 424 into complementary grooved surface 456 to ensure engagement and ease in movement of the shelf 414 “up and down” the multiple parallel components 412.

In the present embodiment, both ends of the extendible end component 452 includes a ratcheting gear for extending end components of both sides of the rod 450 into the motor substantially simultaneously with substantially equal force. Those skilled in the art would recognize the “equal” distribution of “force” into the motor will further ensure ease in the movement of the shelf (or shelves if desired) and reduce wear on single extending portion on only one side of the rod.

The contoured portion 414A is complimentary to fit between the multiple parallel base portion 412 requires the shelf 414 having two extending hinges 430 perpendicular to the rod so as to allow “fit” between the multiple parallel components 412 in the “folded” position when not in use. The ability to fold the shelf to fit between the multiple parallel component ensures a “flat” surface when not in use and more importantly, will direct additional force onto the sound deadening system to eliminate any vibration, rattling or noise in the collapsed position.

It will be recognized by those skilled in the art that the present invention has been described with manual movement of the shelf (via the various motor designs). However, the present invention recognizes the use of automatic movement of the shelf based on the application of“power” from a defined source. Specifically, adding electrical power to drive the motor could easily be applied, e.g. an electric power motor could be directly attached to drive the gear and therefore movement of the shelf. The power source could be from electrical system of a vehicle equipped with an embodiment of the present invention or could be obtain from a power port existing in vehicle. Further, providing a power source with the present invention, e.g. a solar charged power motor complimentary to attachment to the motor of the present invention is within the scope of the invention.

Further, those skilled in the art will recognize, the storage unit of the present invention could be integral with “back seat” of a vehicle without departing from the pressure distribution concepts described herein.

In another embodiment, the invention is directed to a method to a method to organize cargo in a vehicle cargo area storage system comprising securing a cargo device of in a cargo area and adjusting the at least one adjustable shelving unit to a defined position on the multiple parallel components between the bottom portion and a top portion, wherein securing the cargo device comprises positioning the bottom portion of the multiple parallel components of the base portion via the contacting side to a floor of a cargo section of a vehicle and adjusting the connecting component to extend the distal end of the securing system to secure the cushioned contacting foot to a ceiling of the cargo area of a vehicle.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A cargo area storage system comprising:
a. a base structure having multiple parallel components, wherein the multiple parallel components have bottom portion and a top portion;
b. at least one adjustable shelving unit;
c. a sound deadening securing system integral with each multiple parallel components of the base structure; and
d. a motor,
wherein the shelve is aligned perpendicular to the multiple parallel component so as weight on the shelve increases in a perpendicular direction, pressure in engaging into the motor on a first side of the multiple parallel component is increased.

2. The storage system of claim 1, wherein the sound deadening securing system has a distal end and a proximal end, wherein the proximal end is connected to the multiple parallel components via a connecting component, wherein the connecting component allows for adjustable extension of the securing system.

3. The storage system of claim 2, wherein the distal end of the securing system comprises a cushioned contacting apparatus, wherein the cushioned contacting apparatus is designed to disperse pressure provided by the multiple parallel components of the base structure in a substantially perpendicular direction.

4. The storage system of claim 3, wherein the bottom portion of the multiple parallel components of the base portion has a contacting side which is complementary to a supporting structure.

5. The storage system of claim 4, wherein the multiple parallel components of the base structure comprise multiple telescoping components, wherein the securing system extends in the same direction as the telescoping components of the top portion of the base structure, wherein the connecting components has a locking device.

6. The storage system of claim 5, wherein the at least one adjustable shelving unit is integral with the multiple parallel components of the base portion via the motor to allow movement between the top portion and bottom portion of the multiple parallel components.

7. The storage system of claim 6, wherein the deck is retractable.

8. The storage system of claim 6, wherein the motor is a one-piece integrated unit traversed by the multiple parallel component, wherein a gear on a proximal end of the one-piece integrated unit is aligned with a gear surface on a first side of the multiple parallel component, wherein at least one wheel is aligned with a second side of the multiple parallel component, wherein the shelve is aligned with the gear so as weight on the shelve to increases in a perpendicular direction, pressure in engaging the gear into the gear surface on a first side of the multiple parallel component is increased, wherein the increase on the motor directs pressure in a perpendicular direction to the sound deadening securing system and base portion.

9. The storage system of claim 8, wherein the at least one wheel has a contacting surface complementary to the surface of the second side of the multiple parallel component to maintain alignment and substantially eliminate friction contact in a perpendicular direction of the multiple parallel component, wherein the one-piece integrated unit further comprises a retractable brace bar extending from a distal end of the one-piece integrated unit to the distal end of the shelve, wherein the shelf is connected to the one-piece integrated unit via a hinge, wherein each multiple parallel component comprises a hinge proximal its bottom portion, wherein the motor is integral with a drive train contacting the at least one adjustable shelving unit, wherein the drive train is integral with the multiple parallel components of the base portion.

10. The storage system of claim 9, wherein the motor comprises grooves complementary to grooves on the drive train rotating at 360 degrees activate the drive train for movement of the at least one adjustable shelving unit in a parallel direction to the multiple parallel components of the base portion, wherein the weight of the shelf in the extended position ensures the weight on the drive train is distributed to provide “sliding” movement with minimal or no friction on the multiple parallel components.

11. The storage system of claim 6, wherein the adjustable shelving unit has an contoured portion complimentary to fit between the multiple parallel base portion, wherein the countered portion has a first proximal end portion the adjustable shelving unit is traversed by a rod having at least one extendible end component on each end which extends into the motor in greater amounts as the adjustable shelving unit is rotated into an extended position perpendicular to the multiple parallel component.

12. The storage unit of claim 11, wherein the extendible end component comprises a ratcheting gear extending the at least one extendible end component into the motor.

13. The storage unit of claim 12, wherein both ends of the extendible end component comprise a ratcheting gear extending the extending end components of both sides of the rod into the motor substantially simultaneously with substantially equal force.

14. The storage unit of claim 1, wherein the storage unit is integral with a seat within a vehicle.

15. A method to organize cargo in a vehicle cargo area storage system comprising:
a. securing the cargo device of claim 1 or 8 or 11 in a vehicle cargo area;
b. adjusting the at least one adjustable shelving unit to a defined position on the multiple parallel components between the bottom portion and a top portion,
wherein securing the cargo device comprises positioning the bottom portion of the multiple parallel components of the base portion via the contacting side to a floor of a cargo section of a vehicle and adjusting the connecting component to extend the distal end of the securing system to secure the cushioned contacting foot to a ceiling of the cargo area of a vehicle.
